(19) United States
(12) Patent Application Publication
(10) Pub. No.: US 2024/0039728 A1
(43) Pub. Date: Feb. 1, 2024

(54) EFFICIENT USER CONTROL OF THEIR DATA STORED IN A CENTRALISED BIOMETRIC DATABASE

(71) Applicant: MASTERCARD INTERNATIONAL INCORPORATED, Purchase, NY (US)

(72) Inventors: John BERIC, London (GB); Patrik SMETS, Begijnendijk (BE); Prashant SHARMA, Madison, NJ (US)

(73) Assignee: MASTERCARD INTERNATIONAL INCORPORATED, Purchase, NY (US)

(21) Appl. No.: 17/874,830

(22) Filed: Jul. 27, 2022

(51) Int. Cl. H04L 9/32; G06F 21/62

(52) U.S. Cl. CPC H04L 9/3231; G06F 21/6245

(57) ABSTRACT

There is disclosed a computer implemented method (300) of managing user accounts at a biometric database, the biometric database comprising biometric data of a user. The method comprises the steps of: receiving (301), at the biometric database, a message from a user device to suspend a user's account, the message comprising a cryptographic parameter; suspending (303) the user's account, the step of suspending comprising: encrypting (305), at the biometric database, biometric data of the user associated with the user's account using the cryptographic parameter; storing (307), the encrypted biometric data; and discarding (309), at the biometric database, the cryptographic parameter; and transmitting (311), from the biometric database, a message to the user device indicating that the user's account has been suspended.

### FIELD

The present invention relates to a method and system of managing a user's account with a biometric database associated with a service. In particular, suspending a user's account and securely storing the user's data for later use.

### BACKGROUND

The use of biometrics is ever increasing and becoming a commonly used tool for authentication of users. One such use is in personal devices such as smartphones where a biometric template, such as the user's fingerprint, is used to unlock the device, unlock apps, or perform other actions such as make payments online. In these scenarios the biometric template is typically stored locally on the personal device in an encrypted trusted execution environment.

Other uses of biometrics include when a user registers for a particular service, for instance in a building to provide access in and around the building. In this scenario the user may enroll with the service and provide their biometric data to a centralised biometric database which is controlled by the service provider.

In this scenario typically biometric data, such as fingerprint data, is stored in the biometric database as the full biometric template (such as an image of the full fingerprint) or as sufficient data that a useable full biometric template can be recreated.

The centralised biometric database may encrypt and store the user's biometric template with cryptographic keys and parameters stored at the biometric database, so that only the biometric database has the ability to decrypt the user's biometric data.

However, despite the encryption of the biometric templates at the biometric database, associated with the service provider, users may not be satisfied with the fact that the centralised biometric database services are always running, and/or that their biometric data is at risk of a security failure beyond their control. It is common for users enrolled in the service to un-enrol their account after their current use of the service has finished requesting the biometric database to delete their data. When they next use the service, they then have to re-enrol in the service.

Typically, the enrolment process involves authentication and security checks involving a large number of messages being sent between the user's device, the service provider and also third parties involved in the authorisation and checks. Therefore, this de-activation from the service and subsequent enrolment is far from ideal for all parties involved. One of the aims of the following is to solve these problems.

### SUMMARY

According to a first aspect there is provided a computer implemented method of managing user accounts at a biometric database, the biometric database comprising biometric data of a user, the method comprising the steps of: receiving, at the biometric database, a message from a user device to suspend a user's account, the message comprising a cryptographic parameter; suspending the user's account, the step of suspending comprising: encrypting, at the biometric database, biometric data of the user associated with the user's account using the cryptographic parameter; storing, the encrypted biometric data; and discarding, at the biometric database, the cryptographic parameter.

In this way, the user can suspend their account at the biometric database with their biometric data being encrypted with a cryptographic parameter to which, whilst the user account is suspended (i.e., in a suspended state), only the user device has access.

This improves the security of the biometric data, in that, biometric data associated with suspended accounts is securely encrypted with a cryptographic parameter that only the user device has access to. Therefore, if a malicious third party obtains access to the biometric database and/or its data, or if there is a data leak, any third party will be unable to access or utilise this encrypted biometric data of the suspended account.

This provides the user with greater control of their data so that only they can decide whether to re-active their data. Additionally, this provides users with piece of mind that they have full control over their data and that it is secure.

Preferably, the method may further comprise transmitting, from the biometric database, a message to the user device indicating that the user's account has been suspended. This provides the user device with the confirmation that the biometric data has been successfully encrypted.

The biometric database may be associated with a service as will be described in more detail below. By suspending their account, the account is currently not active, i.e., it cannot be used. However, during the suspension the user stays enrolled with the service such that a further step of enrolment is not required if the user wishes to use the user account at a later point in time.

Preferably, the encrypted biometric data may be stored at the biometric database. Thus, the biometric data associated with suspended accounts may be stored at the biometric database. Alternatively, the encrypted biometric data may be stored in a different location to the biometric database when the user account is suspended. For instance, it may be stored at a different server/database external to the biometric database (with the biometric database only storing the biometric data of accounts that are active).

Preferably, the method may further comprise: receiving, at the biometric database, a message from the user device to re-activate the user's account, the message comprising the cryptographic parameter; re-activating the user's account, the step of re-activating comprising: decrypting, at the biometric database, the biometric data of the user associated with the account using the cryptographic parameter; and discarding, at the biometric database, the cryptographic parameter; and transmitting, from the biometric database, a message to the user device indicating that the user's account has been re-activated.

Advantageously, the user can reactive their account without having to go through a further enrolment process. This reduces the number of messages that need to be sent compared to the user un-enrolling and a further re-enrolment as the validation, and security checks required during the enrolment process do not need to be performed again. This reduces the computing resources required at the biometric database, due to there being fewer messages and checks required, during this procedure and thus less messages being sent thereby reducing the load on the biometric database, and third party, resources.

Preferably, the cryptographic parameter to re-activate the user's account may be the same cryptographic parameter used to encrypt the data when the account was suspended.

In some arrangements. the message from the user device to suspend a user's account is a first message and comprises a first cryptographic parameter, and the method further comprises after re-activating the user's account: receiving, at the biometric database, a second message from a user device to suspend a user's account, the message comprising a second cryptographic parameter; suspending the user's account, the step of suspending comprising: encrypting, at the biometric database, biometric data of the user associated with the account using the second cryptographic parameter; storing, (preferably at the biometric database), the encrypted biometric data; and discarding, at the biometric database, the second cryptographic parameter; and transmitting, from the biometric database, a second message to the user device indicating that the user's account has been suspended.

Preferably, the second cryptographic parameter may be different to the first cryptographic parameter. In this way, each time the user's account is suspended a different cryptographic parameter may be used to encrypt the data. Advantageously, this provides increased security compared to the same cryptographic parameter being used each time the user account is suspended, in case, for instance, if a previous cryptographic parameter had previously been intercepted. In other arrangements the second cryptographic parameter may be the same as the first cryptographic parameter.

Preferably, the biometric data may be a biometric template. The biometric template comprises a set of stored biometric features of the user. The biometric template represents the biometric sample of the user. The biometric template may include: a fingerprint, retinal scan, facial recognition, voice recognition, iris recognition, or any other type of biometric of a user. The biometric template comprises an image of the whole biometric feature. For instance, an image of the entire fingerprint. In other arrangements, the biometric data may comprise an image of part of the biometric feature. In other arrangements, the biometric data may be data that represents the biometric. In other arrangements the biometric data may be biometric data that is sufficient data that a useable full biometric template can be recreated.

Preferably, the cryptographic parameter may be an Initialization Vector. In other arrangements, the cryptographic parameter may be any type of cryptographic variable.

Preferably, the step of encrypting biometric data of the user associated with the account using the cryptographic parameter may further comprise using a security parameter known to the biometric database. The security parameter may be a cryptographic key.

The Initialization Vector (IV) provided by the user device and the cryptographic key known to (i.e., stored) at the biometric database may be used to encrypt the biometric data of the suspended user account. Advantageously, this provides a double lock system with the biometric database and the user device providing a separate component of the encryption algorithm. To decrypt the data both the security parameter from the biometric database and the cryptographic parameter from the user device are required.

Preferably, the encrypted biometric data associated with the suspended user account may be further encrypted by the biometric database using only cryptographic parameters known to (i.e., stored at) the biometric database. This provides a further level of encryption using cryptographic key(s) only known to the biometric database and/or a secure third party. In some arrangements, all biometric data stored at the biometric database may be encrypted by the biometric database with key(s)/cryptographic parameters only known to the biometric database and/or a secure third party. This provides the standard level of security necessary for the biometric database to store user's data. However, the user does not have any control over this encryption as it is using only cryptographic parameters known to (i.e., stored at) the biometric database. Preferably, the biometric data associated with the suspended user account may be encrypted using the cryptographic parameter from the user device without removing this standard level of encryption. In other words, the encrypted biometric information is further encrypted when the account is suspended using the cryptographic parameter from the user device.

In some arrangements, the method may further comprise: receiving, at the biometric database, a message from the user device to enrol the user with the biometric database; receiving, at the biometric database, biometric data of the user; generating, at the biometric database, a user account associating the biometric data with a user identity thereby enrolling the user with the biometric database.

The enrolling step is the initial step which causes the user's account to be created. The biometric data provided by the user is linked with the user's identity. The user's identity may include any of name, contact details, age, user device ID, or any other personal details. These details may also be encrypted along with the biometric data.

The messages between the user device and the biometric database may be sent over a secure channel. Preferably the messages may be encrypted and/or authenticated data channel. The data channel may be TLS or any other type of secure channel. Advantageously, this provides a secure link between the user device and the biometric database.

Preferably, the method may further comprise: authenticating the user at the biometric database, the step of authentication comprising: receiving a request to authenticate the user, the request comprising biometric data of the user; comparing the received biometric data of the user with the biometric data of the user associated with the account; and based on the comparison, deciding whether to authenticate the user; wherein the step of authenticating is not permitted when the user's account is suspended.

In this way, the user can be authenticated by the biometric database for use of the service. The authentication is only possible whilst the user account is still activated, i.e., not suspended. During the suspended state the user account is not active and therefore the user cannot use the service until it is re-activated.

The request to authenticate the user may come from a third party. The third party may be a device configured to capture the biometric data of the user. For instance, the third party may be a scanning device, such as a fingerprint (or other biometric) scanner. In other arrangements the request to authenticate may originate from the user device.

Preferably, the authentication may be authentication of whether a user is permitted to perform a certain action, preferably said certain action may include: access to or within a building, transport system, and/or leisure facility. In other arrangements it may enable issuance of tickets or services to the user.

For instance, the biometric database may be associated with a service that controls access to a building. The authentication by the biometric database may permit the user to access the building. In some arrangements, a biometric scanner housed within the building may capture the user's biometric data and send this to the biometric database for authentication. Once authentication is confirmed the user may be provided access to the building. The building may be an office, home, or leisure facility. In other arrangements, it may permit access to and/or around a transport terminal. For instance, a user may be permitted through a transport gate or barrier, and/or access to transportation upon successful authentication.

In other arrangements, the action may be access to a controlled resource. For instance, the controlled resource may be a medicine and authentication may provide controlled dispense of the medication. In other arrangements, the action may be a payment. Authentication may enable the user to make a payment, and/or receive a payment/funds.

Preferably, the method may further comprise: sending, from the user device, a message from the user device to suspend the user's account, the message comprising the cryptographic parameter; storing, at the user device, the cryptographic parameter; receiving, at the user device, the message indicating that the user's account has been suspended.

The method may further comprise transmitting, from the user device, the message from the user device to re-activate the user's account, the message comprising the stored cryptographic parameter.

The parameter sent by the user device to suspend the user's account is the same parameter as transmitted from the user device to re-activate the user's account. By storing the cryptographic parameter only at the user device, and not at the biometric database, only the user device has the parameter required to de-crypt the biometric data when the user account is suspended. This provides improved security as if the biometric data is subject to a malicious attack or there is a data leak the encrypted biometric data cannot be accessed.

The method may further comprise generating, at the user device, the cryptographic parameter. In this way, the cryptographic parameter may be generated at the user device before being sent to the biometric database for use in encryption. Each time the user account is suspended the user device may generate a new cryptographic parameter. In other arrangements, the user device may use the same parameter, the parameter being one only known to the user device.

The user device may comprise an application that is configured to generate and send the messages to the biometric database. The app may display a user interface providing the user with the option to suspend their user account. Upon selecting the option to suspend their user account the app may cause the user device to perform the above steps to suspend the user account. The app may then display a user interface providing the user with the option to re-activate their user account. Upon selecting the option to re-activate their user account the app may cause the user device to perform the above steps to re-activate the user account. The app may generate the encrypted and/or authenticated data channel between the user device and the biometric database.

The cryptographic parameter may be stored at a secure location at the user device. This may include at a trusted execution environment on the user device. By storing the cryptographic parameter locally at the user device, it is stored at a different location to the encrypted data thereby improving security.

According to a further aspect there is provided a biometric database comprising user accounts, each user account having associated biometric data of a user, the biometric database comprising at least one processing circuitry configured to perform the method of the above aspect.

According to a further aspect there is provided a user device, comprising at least one processing circuitry configured to perform the method of: sending, from the user device, a message to a biometric database to suspend a user's account, the message comprising a cryptographic parameter; storing, at the user device, the cryptographic parameter; and preferably receiving, at the user device, a message indicating that the user's account has been suspended.

The method may further comprise transmitting, from the user device, a message to the biometric database to re-activate the user's account, the message comprising the stored cryptographic parameter. The stored cryptographic parameter may be the IV that is stored at the user device.

The user device may comprise a mobile phone, such as a smart phone. In other arrangements, the user device may be a tablet, a personal computer (such as a laptop or desktop), a smart watch or other type of wearable, or any other type of computing device.

According to a further aspect there is provided a system comprising the biometric database of the above aspect and the user device of the above aspect.

According to a further aspect there is provided a non-transitory computer-readable storage medium storing instructions thereon which, when executed by one or more processors, cause the one or more processors to perform the method of the above aspect.

### BRIEF DESCRIPTION OF FIGURES

Embodiments of the present invention are described below, by way of example only, with reference to the accompanying drawings, in which:

FIG. 1 shows a schematic view of a system including a user device in communication with a biometric database during enrolment of a user creating a user account at the biometric database according to an embodiment of the invention;

FIG. 2 shows a system including a user device in communication with a biometric database when suspending the user's account at the biometric database according to an embodiment of the invention;

FIG. 3 shows a system including a user device in communication with a biometric database when re-activating the user's account at the biometric database according to an embodiment of the invention;

FIG. 4 shows a message flow diagram between a user device and a biometric database illustrating the enrolment, suspension and re-activation process for managing user accounts at a biometric database according to an embodiment of the invention;

FIG. 5 shows a message flow diagram between a biometric reader and a biometric database illustrating the authorisation process for user accounts at a biometric database according to an embodiment of the invention;

FIG. 6 is a flow chart showing a computer implemented method of managing user accounts at a biometric database according to an embodiment of the invention; and

FIG. 7 shows a data processing device according to an embodiment of the present disclosure capable of performing the method of any of FIGS. 4, 5, and 6.

### DETAILED DESCRIPTION

The present invention relates to temporarily suspending user's accounts when they are enrolled in a biometric database associated with a service. The user's device sends to the biometric service provider (i.e., biometric database), along with the request for suspension, a cryptographic parameter, such as an initialisation vector. This cryptographic parameter is then used by the biometric service provider, along with its own cryptographic key, to encrypt the biometric data associated with the user's account when the user's account is suspended. The cryptographic parameter is then only stored at the user's device such that the user has sole control over whether the biometric data can be decrypted. This provides a secure way of storing the biometric data, and which gives the user control of the security of their data, whilst not requiring the user to delete their account at the service provider which would entail the user to go through the lengthy and resource heavy enrolment process should they wish to resume the service.

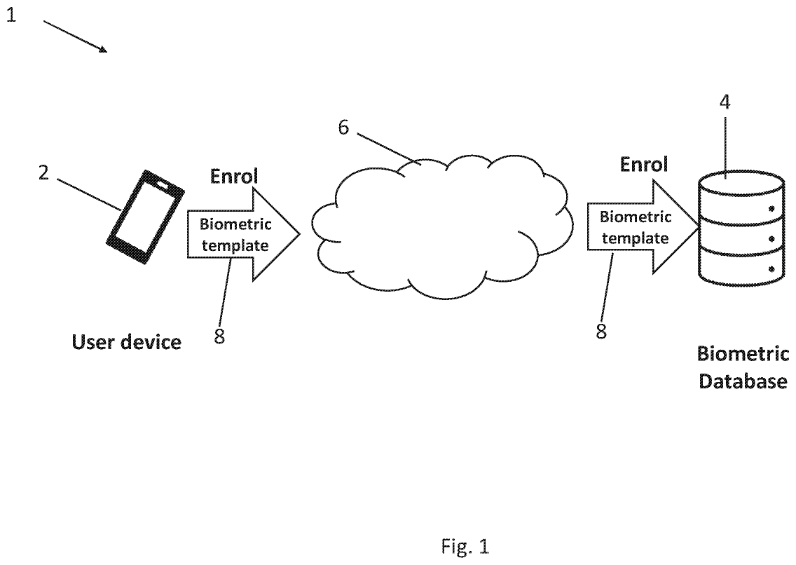

FIG. 1 shows a schematic view of a system 1 involved in the managing of user accounts, otherwise referred to as profiles, according to the present invention. The system 1 comprises a user device 2 in communication via network 6 (in this instance the internet) to biometric database 4.

The user device 2 is a mobile device on which the user controls their access to the biometric database 4. The user device 2 includes a biometric reader, such as a fingerprint or retinal scanner, which is capable of capturing biometric images of the user's biometric.

The biometric database 4 is associated with a service to which the user wishes to register and use. For instance, the service may be a building management service that controls access to and within a building—such as access to doors, lifts, or other amenities in the building. Although the biometric database 4 is shown as a single entity acting as a database it would be understood that while in some arrangements a single entity may be present, in other arrangements multiple different servers may make up the biometric database which are involved in managing user accounts and the services provided. Additionally, there may be other entities that are involved in the service managed by the database that are in communication with the biometric database 4. For instance, there may be a control unit that is in communication with the biometric database 4 that is responsible for controlling access to doors upon successful authorisation of a user by the biometric database 4. The number and type of entities making up the biometric database 4, and the system providing the service, will depend upon the services provided.

The biometric database 4 stores user accounts for multiple different users who are enrolled in the service. Each user account contains personal identifiers of the user, such as name, ID number (e.g., passport, driving license number, account details), user device identifier. Additionally, a biometric template of the user is also stored in the user account associated with the personal identifier of the user. The user account permits the user to access the service, as will be described in greater detail below.

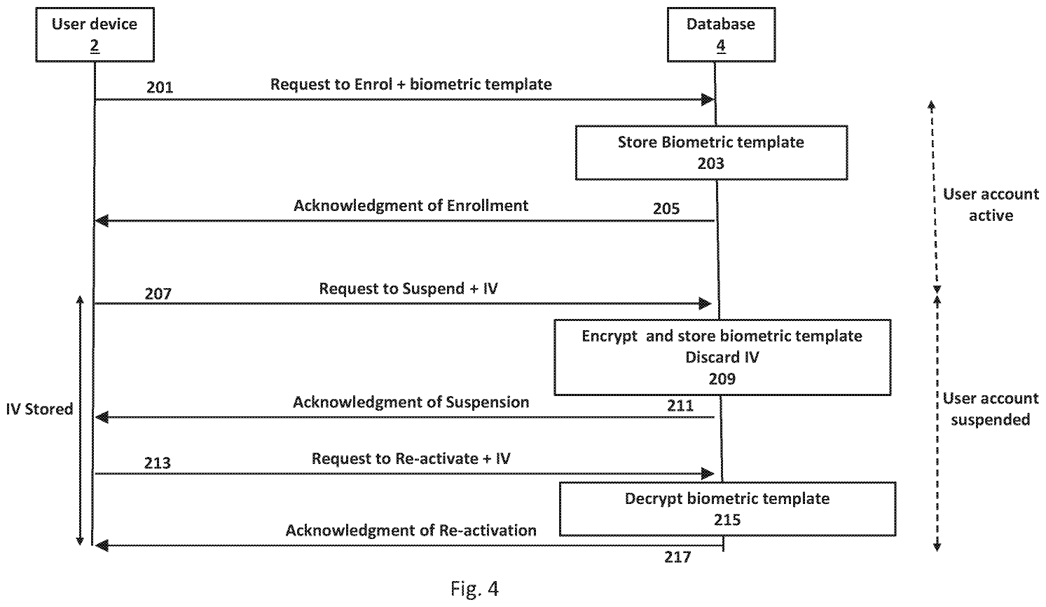

FIG. 1 represents the system 1 during the enrolment process when a user wishes to enrol in the service provided by a centralised biometric database 4 and set up a user account. Steps of the enrolment procedure are also shown in FIG. 4 which will be referenced in the description here.

In this procedure the user launches, on their device 2, an app associated with the service provided by the biometric database 4. The user then can select an option to enrol in the service and may be instructed to provide their biometric to the user device's biometric reader. This may involve providing their finger to the fingerprint scanner on the device 2, but any other type of biometric and biometric reader may be used. The biometric reader then captures an image of the biometric and stores this as a biometric template at the user device. This storage at the user device 2 may be temporary or may be long term with the biometric template stored in the secure environment of the user device 2.

The user device 2 then sends the biometric template in a secure message 8 via network 6 to the biometric database 4 as a request to enrol in the service. This is shown in step 201. A secure connection, such as TLS, is set up between the biometric database 4 and the user device 2 when launching the app on the user device 2. This connection is encrypted and authenticated data channel to ensure that the data is secure if the connection was comprised.

Once the request to enrol is received at the biometric database 4 a number of checks are performed involving multiple messages sent from the database 4 to third parties to determine the authenticity of the user. This may require some endorsement from a trusted third party which can only be conducted and completed through non-trivial authenticated interactions. Typically, enrolment requires evidence from the trusted third party that a particular biometric template can be bound to the particular identity. The third party may be an entity of authority or having already authenticated details on the user, such as bank, passport/government office, or any other regulatory office. In addition, as well as multiple messages sent to third parties for authentication during enrolment, the enrolment may also require the user to provide the evidence in person (although this is not always essential) which, if required, is burdensome to repeat frequently.

The user account is then set up at the biometric database 4 with the user then able to access the service provided by the database 4. The received biometric template is associated with the user's account and stored at the biometric database 4, as shown in step 203. This biometric template, and the user's other personal data is encrypted by the biometric database 4 using cryptographic keys known to the database 4, thus providing the biometric database with the ability to decrypt the biometric template and user's data whenever required.

An acknowledgment, as shown in step 205, is then sent to the user device 2 indicating that the user has successfully enrolled with the service and is now free to use the service. In this state the user's account is described as being active. This means that the user may freely use the service and by presenting their biometric to a reader, such as on the user device 2 or an external biometric reader associated with the service, the service can authenticate their identity to allow them to use the service—as will be described in further detail below.

Once enrolled the user may decide that they no longer wish to have their account active. For instance, they may only use the service intermittently, such as a period of high use followed by a period of no use. For instance, if the service is for accessing a building the user may only occasionally visit the building. In a period where they are not using the service for an extended period, they may not want their biometric template being stored at the biometric database 4 due to risk of their biometric template being subject to a data breach.

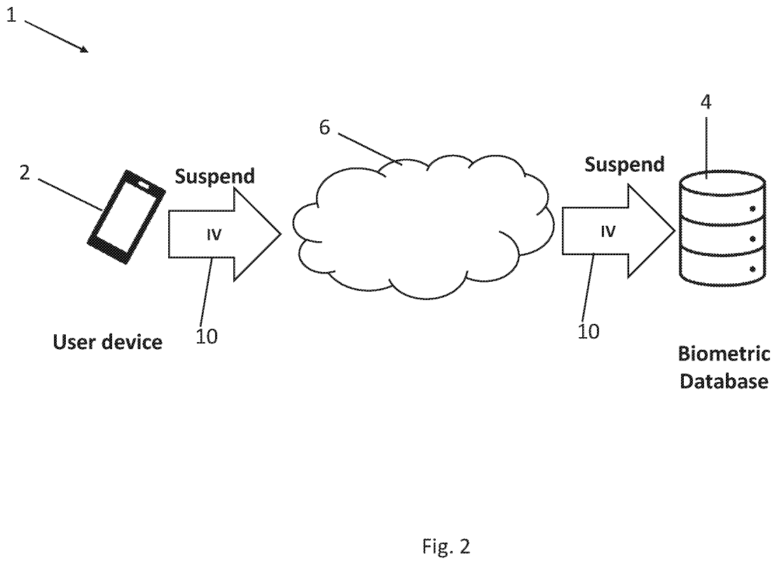

FIG. 2 represents the system 1 during a suspend process providing the user the ability to temporarily de-active their user account with the service. Steps of the suspend procedure are also shown in FIG. 4 which will be referenced in this description here.

When the user wishes to temporarily suspend their user account associated with the service, they can launch the app associated with the service on their user device 2. The app provides the user with the option to “suspend their account”. The app then prompts the user device 2 to generate a cryptographic initialisation vector (IV) to be sent to the biometric database 4. A suspend message 10 is then sent to the biometric database 4 over the secure connection (as described above with respect to the enrolment process). The request to suspend is sent along with the IV to the biometric as set out in step 207.

Once the request to suspend and the IV is received at the biometric database 4 the user account is identified from an identifier sent in the request. The biometric template associated with the account is then further encrypted by the database 4 using the IV sent from the user device along with a cryptographic key and encipherment algorithm of the biometric database 4. The encrypted biometric template is then stored by the biometric database 4. This is shown in step 209. Advantageously, this provides a double lock system with the biometric database 4 and the user device 2 providing a separate component used by the encryption algorithm to encrypt the biometric data during this suspension of the user's account. To decrypt the data both the security parameter from the biometric database 4 and the cryptographic parameter from the user device 2 are required.

In some arrangements, this encryption may be on top of the encryption already present on the biometric template that had been applied by the database 4 using the database's keys (as mentioned above in the enrolling process). However, in other arrangements this initial database encryption may have been removed prior to encrypting when entering the suspended state using the IV from the user device. The encryption using the IV may be encryption of only the biometric template or may include encryption of the biometric template and any other personal identification information stored about the user at the biometric database 4.

Once the biometric template has been encrypted the IV is permanently deleted by the database 4. However, the user device 2 stores the IV in a secure location on the user device 2 so that the biometric template can be decrypted at a later point in time. In this way, as only the user device 2 has access to the IV only the user device 2 has the means to decrypt the biometric template. This means that the user device 2 can maintain control over the biometric template when the user account is in the suspended state. Therefore, if the biometric database 4 is compromised, due to a security breach for instance, then the biometric template of the suspended account cannot be accessed by the malicious third party. This can provide further piece of mind to the user as only their user device 2 has the IV required for decrypting the data.

Once the account has been suspended the biometric database 4 may then acknowledge the suspension to the user device 2 through message 211. During the entirety of the suspended state the user device stores the IV. Alternatively, in other arrangements the IV may not be stored by the user device 2 and may also be discarded. However, if this is the case the user device 2 has the means to re-generate the same IV again when later required to re-active the account.

The suspension may occur whilst the user is not using the account for an extended period of time. However, after a period of time the user may wish to resume their use of the service and their account.

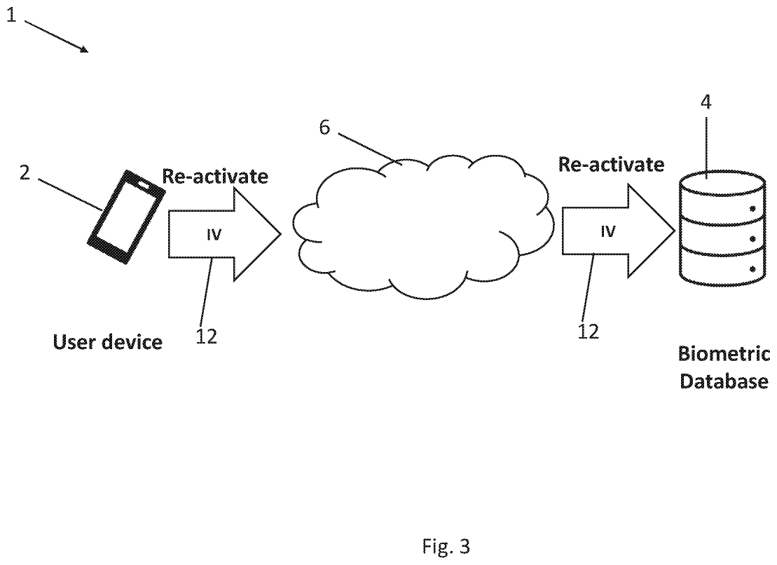

FIG. 3 represents the system 1 during a re-activation process providing the user the ability to re-active (i.e., retore) their user account with the service. Steps of the re-activation procedure are also shown in FIG. 4 which will be referenced in this description here.

When the user wishes to re-activate their account, they launch the app on their user device 2 where they may be presented with the option of “re-activating” their profile with the service. Upon selecting the option of re-activating, the user device 2 obtains the IV from storage (or regenerates the IV if the IV was not stored at the user device 2). The IV is the same IV that was used earlier in the unsubscribe process. The IV is sent in a message 12 to the biometric database 4 over the secure connection along with a request to re-activate the user's account. This is shown in step 213.

Upon receiving the request to re-active the user's account, the biometric database 4 decrypts the stored biometric template associated with the user's account that was encrypted upon the suspension, as shown in step 215. This decryption is performed using the received IV (which is the same IV as used to encrypt the data) and the cryptographic key of the biometric database 4 which was also used for the encryption. Once this decryption has been performed the user's account is then again active. The user can then use the account to interact with the service as intended (as described further below). An acknowledgment of re-activation message is then sent from biometric database 4 to the user device 2 indicating that the account is again active and that the user can use the service. This is shown in step 217.

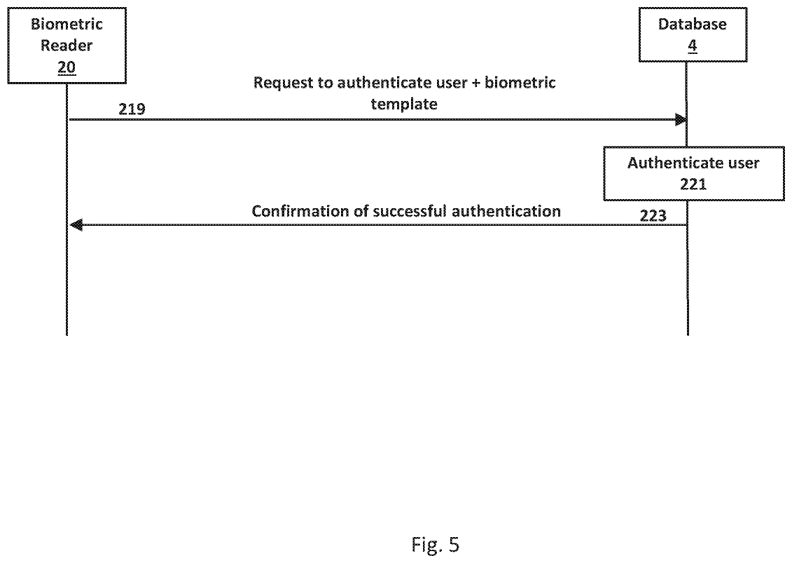

FIG. 5 shows a message flow diagram between a biometric reader (i.e., scanner) 20 and a biometric database 4 illustrating the authorisation process for managing user accounts at a biometric database 4. Biometric reader 20 may be a reader located at the user device 2 as outlined above. Alternatively, the biometric reader 20 may be an external biometric reader that is associated with the user device 2, or in some arrangements not associated with the user device 2. For instance, the biometric reader may be associated with the service with which the biometric database 4 is associated. For instance, in the above-described scenario where the service relates to access in or around a building, the biometric reader 20 may be located on or near a door for permitting or denying access through the door dependent upon authorisation of the user.

The biometric reader 20 may capture a biometric template of the user, for instance an image of the user's fingerprint. The biometric reader then transmits a request 219 to authenticate the user, along with the biometric template, to the biometric database 4. This may be an encrypted connection the same as outlined above in relation to FIG. 4. The database 4 then authenticates 221 the user by comparing the received biometric template to the biometric template associated with a user's account. This may require, before the comparison, the database 4 decrypting the biometric template associated with the user account if the biometric template is only encrypted through encryption based on keys managed by the database 4 (i.e., not the encrypted data of a suspended connection as described in relation to FIG. 4). Upon successful authentication a message confirming successful authentication 223 may be transmitted to the biometric reader 20 which enables the user to proceed with the service, such as opening the door. In other arrangements message 223 may be sent to a different entity that is responsible for controlling the service which user is seeking authentication to use, such as sending the authentication message 223 to a control device responsible for operating the door in the above-described example.

However, if the comparison between the received biometric template in request 219 and the stored biometric template is not a match then the database determines not to authenticate the user. In that case no message 223 is sent, or a message that indicates that the user has failed the authentication. Reasons for a failed authentication include the biometric template not being associated with a user account (i.e., the user has not enrolled in the service), or the user account may be suspended (as described above in relation to FIG. 4).

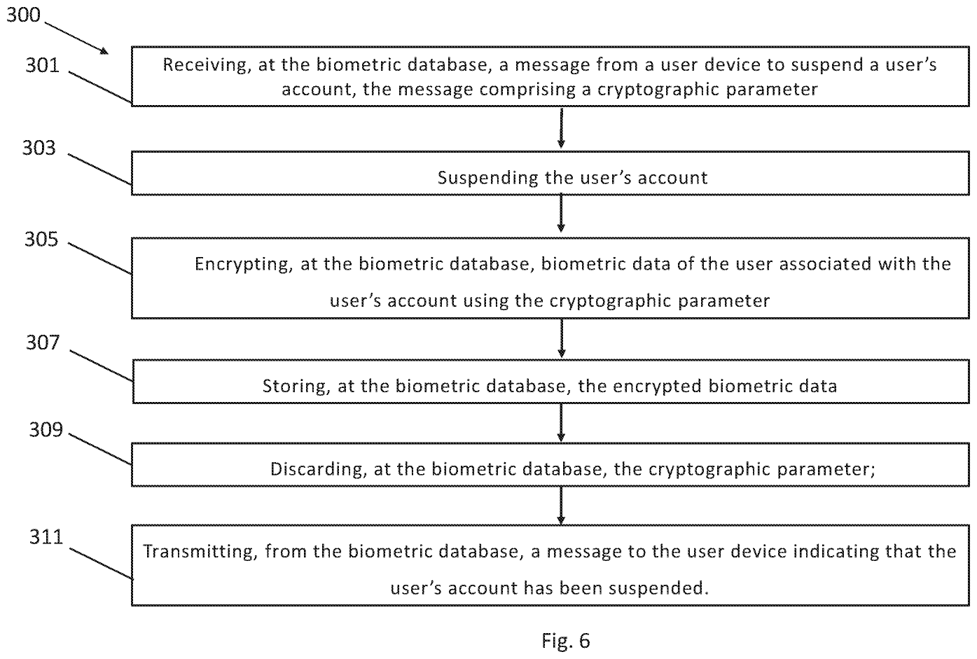

FIG. 6 is a flow chart showing a computer implemented method 300 of managing user accounts at a biometric database according to an embodiment of the invention.

At step 301 a message is received, at the biometric database, from a user device to suspend a user's account, the message comprising a cryptographic parameter.

At step 303 the user's account is suspended.

At step 305 biometric data of the user associated with the user's account is encrypted, at the biometric database, using the cryptographic parameter.

At step 307 the encrypted biometric data is stored at the biometric database.

At step 309 the biometric database discards the cryptographic parameter.

At step 311 a message is transmitted, from the biometric database to the user device, indicating that the user's account has been suspended.

As outlined briefly above the biometric database may be associated with a service that controls access to a building. The authentication by the biometric database may permit the user to access the building or aspects of the building. For instance, a biometric scanner housed within the building may capture the user's biometric and send this to the biometric database for authentication. Once authentication is confirmed the user may be provided access to the building. The building may be an office, home, or leisure facility. In other embodiments, it may permit access to and/or around a transport terminal. For instance, a user may be permitted through a transport gate or barrier, and/or access to transportation upon successful authentication. For instance, the service may be employed at a train station or airport. In the airport arrangement the user may provide their biometric to be authenticated by the biometric database to obtain their flight tickets, pass through security, enter the departure lounge, and/or board the flight.

Other services that the biometric database may be associated with may include a service allowing a user to access a controlled resource. For instance, the controlled resource may be a medicine and authentication may provide controlled dispense of the medication to the user. The authentication by the biometric database may permit the user to access the controlled resource in the same manner as described for the above services. In other arrangements, the service may be a payment service with the authentication allowing the user to make and/or receive a payment upon successful authentication.

However, it would be understood that the methods described herein may be used with any use of service employing a biometric database.

It will be appreciated that any of the methods described herein, and any step of the methods, can be implemented by a computer. Such implementation may take the form of a processor executing instructions stored on a non-transitory computer-readable medium or media, wherein when executed the instructions cause the processor to perform any one or more steps of any of the methods described herein. Individual steps of any method may be implemented by different processors that are all collectively acting in accordance with computer-readable instructions stored on one or more storage media. The processor(s) may be component(s) of system, for example a processor of a device.

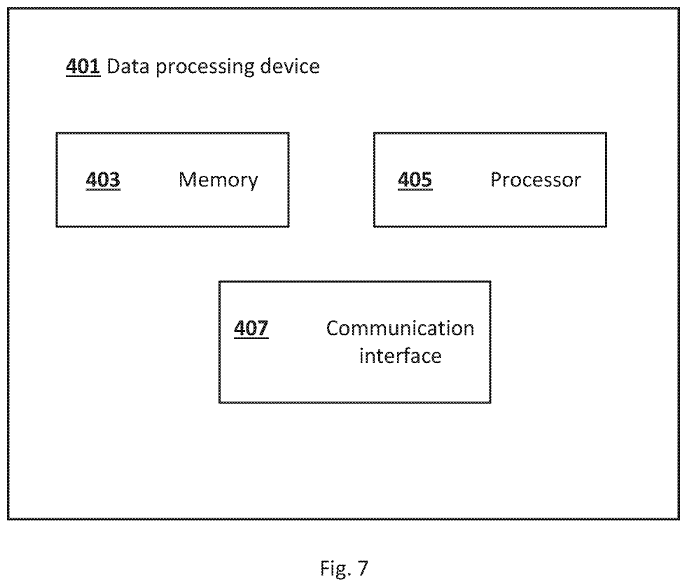

Similarly, any steps of any of the methods described herein may be performed by data processing devices. By way of example, FIG. 7 shows in schematic form a data processing device 401 that is suitable for performing the functions of the user device 2 and/or the database 4. The data processing device 401 may automatically perform any of the methods described herein.

Data processing device 401 includes a processor 405 for executing instructions. Instructions may be stored in a memory 403. Processor 405 may include one or more processing units (e.g., in a multi-core configuration) for executing instructions. The instructions may be executed within a variety of different operating systems on the data processing device 401, such as UNIX, LINUX, Microsoft Windows®, etc. More specifically, the instructions may cause various data manipulations on data stored in memory 403 (e.g., create, read, update, and delete procedures). It should also be appreciated that upon initiation of a computer-implemented method, various instructions may be executed during initialization. Some operations may be required to perform one or more methods described herein, while other operations may be more general and/or specific to a particular programming language (e.g., C, C #, C++, Java, or other suitable programming languages, etc.).

Processor 405 is operatively coupled to a communication interface 407 such that data processing device 401 can communicate with a remote device, such as another data processing device of the system. For example, communication interface 407 may receive communications from another member of the system 1.

The memory 403 may comprise computer-operated hardware suitable for storing and/or retrieving data, where in the case of a secure storage medium the data is stored and retrieved securely. For instance, the memory may store the biometric data. The data processing device 401 may include memory 403 as one or more hard disk drives acting as a storage database. In some arrangements it may comprise multiple storage units such as hard disks or solid-state disks in a redundant array of inexpensive disks (RAID) configuration. The storage database may include a storage area network (SAN) and/or a network attached storage (NAS) system.

Memory 403 may include, but is not limited to, RAM such as dynamic RAM (DRAM) or static RAM (SRAM), ROM, erasable programmable read-only memory (EPROM), electrically erasable programmable read-only memory (EEPROM), and non-volatile RAM (NVRAM). The above memory types are exemplary only and are not limiting as to the types of memory usable for storage of a computer program.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. The methods described herein may be encoded as executable instructions embodied in a tangible, non-transitory, computer readable medium, including, without limitation, a storage device, and/or a memory device. Such instructions, when executed by a processor, cause the processor to perform at least a portion of the methods described herein. Furthermore, as used herein, the term “non-transitory computer-readable media” includes all tangible, computer-readable media, including, without limitation, non-transitory computer storage devices, including, without limitation, volatile and non-volatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As will be appreciated based on the specification herein, the above-described arrangements of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed aspects of the disclosure. The article of manufacture containing the computer code may be made and/or used by executing the code directly from one medium, by copying the code from one medium to another medium, or by transmitting the code over a network.

While the disclosure has been described in terms of various embodiments, the person skilled in the art will recognise that the disclosure can be practiced with modification within the spirit and scope of the claims.

Although it is described herein that the user device 2 has a biometric scanner to capture the user's biometric data, in other arrangements there may be an external biometric scanner that is responsible for capturing the user's biometrics for use in enrolling the user into the service. For instance, the scanner may collect the user's biometrics and send it to the biometric database during the enrolment process. The user device may then control the managing of the account, associated with the biometric, that is created at the biometric database as described above.

It has been described in the above embodiments that a message is transmitted, from the biometric database to the user device, indicating that the user's account has been suspended. This positive acknowledgment provides the user with piece of mind that the account has been suspended. However, in some arrangements this positive acknowledgement (i.e., step 311) may not be necessary as it may be optional, and no message may be sent to the user device indicating that the user's account has been suspended.

The above-described methods set out one example process of enrolment. However, it would be understood that alternative enrolment processes may be used.

In the described processes the network 6 through which the user device 2 and biometric database 4 communicate is the internet. However, in other arrangements any type of network may be used. For instance, it may be a local area network, and/or any type of wireless or wired connection. For instance, it may be a communication network such as 4G, 3G for instance.

The user device 2 may be a mobile device. For instance, as illustrated in FIGS. 1 to 3 it may be a smartphone. However, in other arrangements it may be a personal computer, smart watch/device, tablet, or any other device capable of connecting to a network.

In the above it is described that the app is a mobile app on the smartphone. However, it need not be limited as such. For instance, the user may use a website associated with the service to communicate with the biometric database.

Although cryptographic initialisation vector is described as been generated at the user device any other type of cryptographic parameter may be used. For instance, the cryptographic parameter may be a cryptographic key or combination of IV and a cryptographic key. The cryptographic parameter may instead be a cryptographic algorithm, or a portion thereof.

Although it is shown that the IV and the request to suspend/re-activate are shown as sent in the same messages it may not necessarily be the case. In other arrangements the IV may be sent separately to these messages. In other embodiments, any other known cryptographic techniques, that can be used to embody the idea of dual control over the biometric data held centrally and associated with data subjects, may be used.

In other arrangements, the suspension may not be caused by the user initiating the suspension (such as on the app) and instead the user device may automatically determine after a period of time has elapsed that the user account should be suspended and initiate the suspension.

The term biometric database is used throughout. However, it would be understood that this may comprise any servers that are part of the biometric service provider that are involved in the storage of a user's biometric data, and not necessarily limited to only a database.

The biometric data outlined in the above embodiments is a biometric template. The biometric template comprises a set of stored biometric features of the user. The biometric template represents the biometric sample of the user. The biometric template may include: a fingerprint, retinal scan, facial recognition, voice recognition, iris recognition, or any other type of biometric of a user. The biometric template comprises an image of the whole biometric feature. For instance, an image of the entire fingerprint. In other arrangements, the biometric data may comprise an image of part of the biometric feature. In other arrangements, the biometric data may be alternative data that represents the biometric, rather than a biometric template.

In the above described arrangements, the biometric template that is encrypted, when suspended, is stored in the biometric database. However, in other arrangements the encrypted biometric data associated with the suspended user account may be stored in an external server that is separate to the biometric database where the biometric data associated with the active user accounts are stored.

In the above-described embodiments, the entire biometric template is encrypted. However, in other arrangements only a portion of the biometric template may be encrypted (i.e., just enough to ensure that the biometric cannot be used). This may advantageously reduce the amount of encryption of data that is needed providing targeted control.

1. A computer implemented method of managing user accounts at a biometric database, the biometric database comprising biometric data of a user, the method comprising the steps of:
receiving, at the biometric database, a message from a user device to suspend a user's account, the message comprising a cryptographic parameter;
suspending the user's account, the step of suspending comprising:
encrypting, at the biometric database, biometric data of the user associated with the user's account using the cryptographic parameter;
storing, the encrypted biometric data; and
discarding, at the biometric database, the cryptographic parameter; and
transmitting, from the biometric database, a message to the user device indicating that the user's account has been suspended.

2. The computer implemented method of claim 1, comprising
receiving, at the biometric database, a message from the user device to re-activate the user's account, the message comprising the cryptographic parameter;
re-activating the user's account, the step of re-activating comprising:
decrypting, at the biometric database, the biometric data of the user associated with the account using the cryptographic parameter; and
discarding, at the biometric database, the cryptographic parameter; and
transmitting, from the biometric database, a message to the user device indicating that the user's account has been re-activated.

3. The method of claim 2, wherein the message from the user device to suspend a user's account is a first message and comprises a first cryptographic parameter, and the method further comprises after re-activating the user's account:
receiving, at the biometric database, a second message from a user device to suspend a user's account, the message comprising a second cryptographic parameter;
suspending the user's account, the step of suspending comprising:
encrypting, at the biometric database, biometric data of the user associated with the account using the second cryptographic parameter;
storing, the encrypted biometric data; and
discarding, at the biometric database, the second cryptographic parameter;
and
transmitting, from the biometric database, a second message to the user device indicating that the user's account has been suspended.

4. The method of claim 3, wherein the second cryptographic parameter is different to the first cryptographic parameter.

5. The method of any preceding claim, wherein the biometric data is a biometric template.

6. The method of any preceding claim, wherein the cryptographic parameter is an Initialization Vector.

7. The method of any preceding claim, wherein the step of encrypting biometric data of the user associated with the account using the cryptographic parameter further comprises using a security parameter known to the biometric database.

8. The method of any claim 7, wherein the security parameter is a cryptographic key.

9. The method further comprising:
receiving, at the biometric database, a message from the user device to enrol the user with the biometric database;
receiving, at the biometric database, biometric data of the user;
generating, at the biometric database, a user account associating the biometric data with a user identity thereby enrolling the user with the biometric database.

10. The method of any preceding claim, further comprising:
authenticating the user at the biometric database, the step of authentication comprising:
receiving a request to authenticate the user, the request comprising biometric data of the user;
comparing the received biometric data of the user with the biometric data of the user associated with the account; and
based on the comparison, deciding whether to authenticate the user;
wherein the step of authenticating is not permitted when the user's account is suspended.

11. The method of claim 10, wherein the authentication may be authentication of whether a user is permitted to perform a certain action, preferably said certain action may include any of: access to or within a building, transport system, and/or leisure facility, access to a controlled resource, and/or to make a payment.

12. The method of any preceding claim, further comprising:
sending, from the user device, a message from the user device to suspend the user's account, the message comprising the cryptographic parameter;
storing, at the user device, the cryptographic parameter;
receiving, at the user device, the message indicating that the user's account has been suspended; and optionally
transmitting, from the user device, a message from the user device to re-activate the user's account, the message comprising the stored cryptographic parameter.

13. A biometric database comprising user accounts, each user account having associated biometric data of a user, the biometric database comprising at least one processing circuitry configured to perform the method of any of claims 1 to 11.

14. A user device, comprising at least one processing circuitry configured to perform the method of:
sending, from the user device, a message to a biometric database to suspend a user's account, the message comprising a cryptographic parameter;
storing, at the user device, the cryptographic parameter;
receiving, at the user device, a message indicating that the user's account has been suspended; and optionally
transmitting, from the user device, a message to the biometric database to re-activate the user's account, the message comprising the stored cryptographic parameter.

15. A system comprising the biometric database of claim 13 and the user device of claim 14
